(19) United States
(12) Patent Application Publication
(10) Pub. No.: US 2022/0412397 A1
(43) Pub. Date: Dec. 29, 2022

(54) DEVICE WITH ADJUSTED PAUSE-TYPE HINGE

(71) Applicant: EBN Technology Corp., New Taipei City (TW)

(72) Inventors: CHIEN-LONG LIN, New Taipei City (TW); MING-JEN KUO, New Taipei City (TW)

(21) Appl. No.: 17/361,219

(22) Filed: Jun. 28, 2021

(51) Int. Cl. F16C 11/04

(52) U.S. Cl. CPC F16C 11/04; E05Y 2900/606; E05Y 2201/218; E05D 11/1007

(57) ABSTRACT

In a device with adjusted pause-type hinge, a holding portion and a fixing axis are combined to form a pause-type hinge, the holding portion has a shaft joint portion and an extending portion, the fixing axis passes through the shaft joint portion and the extending portion in shaft manner for rotating and combined to the holding portion, the holding portion has a protruding portion, the fixing axis has at least one fixing hole, and the protruding portion is elastically stretched and engaged with the fixing hole to form a pausing position of a corresponding angle.

### BACKGROUND OF THE INVENTION

### Field of the Invention

The preferred embodiment of the present invention relates to a device with a hinge, and in particular to a device with an adjusted pause-type hinge.

### The Prior Arts

In the prior art, to adjust the angle of the screen of the display, there are fixed structures to fix the angle of the orientation, and an adjustable structure to allow the user to adjust the angle of the display screen with a bracket as the environment changes. The angle can produce better display clarity. In addition, the adjustable structure can be used to rotate the display, which can be used in vehicles, medical purposes, and trading platforms at store counters.

The prior art adopts a general hinge, and it is not easy to hold the display at a specific rotation angle under long-term use. In addition, after the adjustable structure of the prior art fails, the entire set of displays needs to be disassembled, which is not easy to maintain.

### SUMMARY OF THE INVENTION

The purpose of the present invention is to provide a device with an adjusted pause-type hinge to solve the shortcomings of the prior art. The technical means of the present invention for the device with an adjusted pause-type hinge, comprising: A holding portion and a fixing axis are combined to form a pause-type hinge, the holding portion has a shaft joint portion and an extending portion, the fixing axis passes through the shaft joint portion and the extending portion in shaft manner for rotated and combined in the holding portion, the holding portion has a protruding portion, the fixing axis has at least one fixing hole, and the protruding portion is elastically stretched and engaged with the fixing hole to form a pausing position of a corresponding angle.

In an embodiment of the present invention, a device with an adjusted pause-type hinge is provided, further including: A first seat body, the first seat body connected to the holding portion; and a second seat body, the second seat body is connected to the positioning shaft, the first seat body is rotated on the second seat body through a common axle center of the holding portion and the fixing axis, and at the pausing position of the corresponding angle, which is formed by the first seat body and the second seat body.

In an embodiment of the present invention, a device with an adjusted pause-type hinge is provided, the holding portion further includes: An accommodating hole, the accommodating hole penetrates the holding portion; A spring, the spring is accommodated in the accommodating hole, the protruding portion is attached to one end of the spring, and the protruding portion is stretched to one end of the accommodating hole by the spring; and A screw nut, which is screwed to the other end of the accommodating hole, so as to hold the other end of the spring.

In an embodiment of the present invention, a device with an adjusted pause-type hinge is provided, wherein the fixing axis has a structure with different shaft diameters extending from an axle center of the fixing axis, and the fixing axis further includes: A supporting shaft is located at one end of the fixing axis, the supporting shaft is rotated and combined in the extending portion in shaft manner; A ring shaft is adjacent to one end of the supporting shaft, and the ring shaft is rotated and combined in the extending portion in shaft manner; A fixed-point axis is adjacent to the other end of the ring shaft, the fixed-point axis has the fixing hole, and the fixing hole is recessed on the surface of the fixed-point axis; and A fixed shaft is adjacent to the other end of the fixed-point axis, and the fixed shaft penetrates the shaft joint portion.

In an embodiment of the present invention, a device with an adjusted pause-type hinge is provided, wherein a shaft diameter of the fixed shaft from the axle center and a shaft diameter of the clamp shaft from the axle center are respectively larger than a shaft diameter of the fixed-point axis from the axle center, and the protruding portion is elastically stretched between the fixed shaft and the ring shaft.

In an embodiment of the present invention, a device with an adjusted pause-type hinge is provided, wherein the first seat body includes: Two tanks are located at both ends of the first seat body, and the tank has a notch; A slot cover, the two tanks are connected by the slot cover; At least one fixing groove, the fixing groove is located inside the slot cover; and A side cover is combined with the slot cover to form a cavity for accommodating the holding portion and the fixing axis.

In an embodiment of the present invention, a device with an adjusted pause-type hinge is provided, wherein the second seat body has two shaft jointing slots, and one end of the fixing axis is located in a cavity of the shaft-jointing slot.

In an embodiment of the present invention, a device with an adjusted pause-type hinge is provided, wherein a buckling piece is provided on one side of the holding portion, and the buckling piece is engaged with the fixing groove.

In an embodiment of the present invention, a device with an adjusted pause-type hinge is provided, wherein the side cover is combined with the slot cover as a combined body which is accommodated between the two shaft jointing slots.

In an embodiment of the present invention, a device with an adjusted pause-type hinge is provided, further including: A bearing shaft and a linking portion are combined to form a hinge, wherein the bearing shaft is connected to the second seat body, and the linking portion is connected to the first seat body.

The technical means of the present invention, a holding portion and a fixing axis are provided to be combined to form a pause-type hinge, and the protruding portion is elastically stretched between the ring shaft and the fixed shaft, and can be correspondingly positioned in a plurality of fixing holes to form the positioning angle of the pause-type. Through the corresponding rotation of the first seat body and the second seat body, the generated torque pushes the pause-type hinge to be rotated. When they are rotated to the required angle, the protruding portion is elastically snapped into the fixing hole to form the positioning and fixing location of the first seat body and the second seat body. If they need to be selected another corresponding angle of the first seat body and the second seat body, they can keep on rotating correspondingly by way of the first seat body and the second seat body, and the generated torque pushes the pause-type hinge to be rotated so as to enter the selected position of another pause-type positioning. The technical means of the invention, provided in that a screw nut to be screwed the spring into the accommodating hole of the holding portion. Therefore, when the spring is fatigue in elasticity, the spring in the accommodating hole can be replaced by opening the screw nut. The technical means of the invention is that a combination of the side cover and the slot cover is provided. The side cover can be screwed to the inside of the slot cover via screws. Therefore, when the side cover is disassembled during maintenance, the assembly holding portion and fixing axis can be quickly replaced.

### BRIEF DESCRIPTION OF THE DRAWINGS

FIG. 1 is a schematic diagram of the top and side view of the present invention.

FIG. 2 is a schematic diagram of the decomposition of the present invention.

FIG. 3 is a schematic diagram of the side view without the side cover of the present invention.

FIG. 4 is a schematic diagram of a hinge element and a pause-type hinge element.

FIG. 5A is a schematic diagram of the pausing position corresponding to an angle of 30 degrees.

FIG. 5B is a schematic diagram of the pausing position corresponding to an angle of 60 degrees.

FIG. 5C is a schematic diagram of the pausing position corresponding to an angle of 90 degrees.

### DETAILED DESCRIPTION OF THE PREFERRED EMBODIMENT

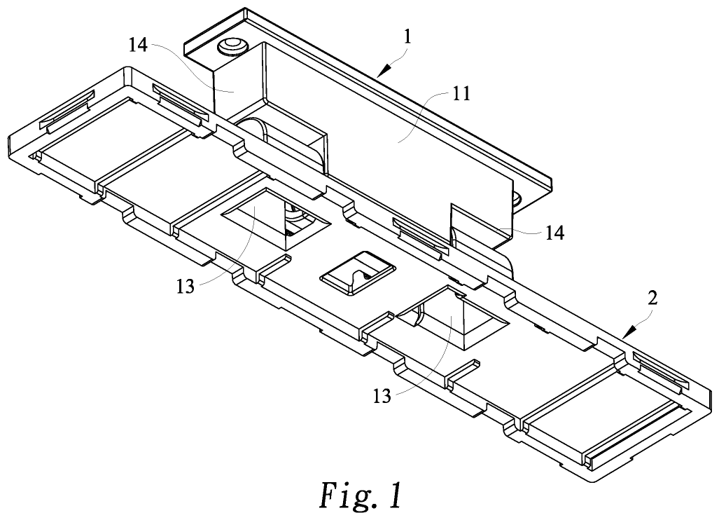

As shown in FIG. 1, a device with an adjusted pause-type hinge according to an embodiment of the present invention, includes: a first seat body 1 and a second seat body 2, and the display screen is supported at different rotating angle to hold the display screen at a specific rotating angle.

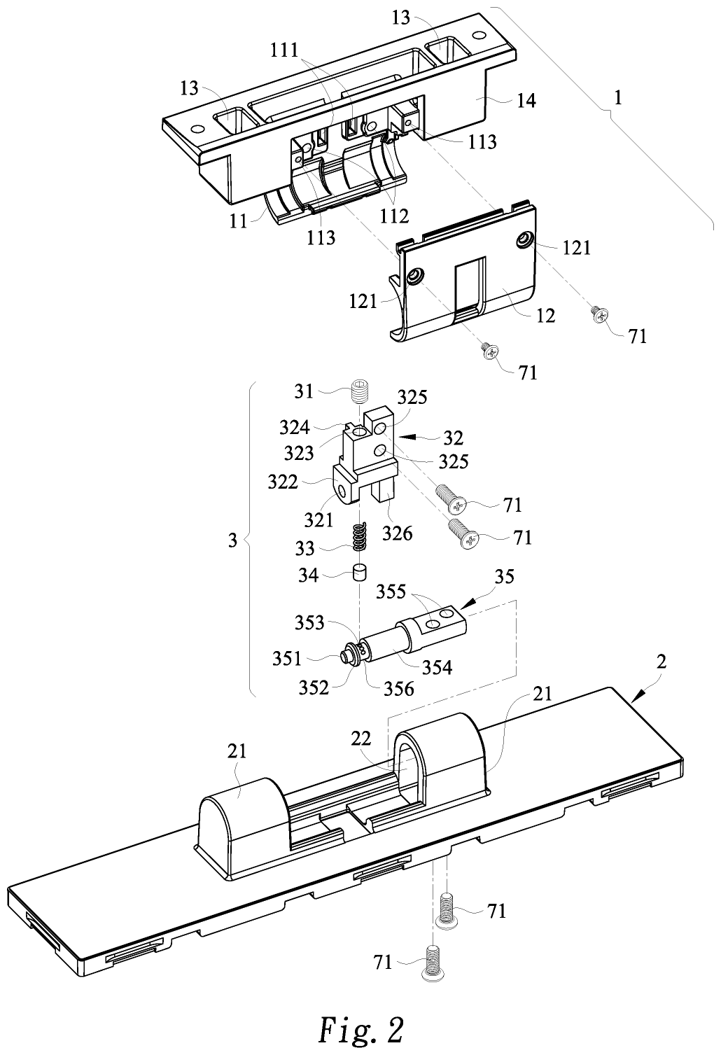

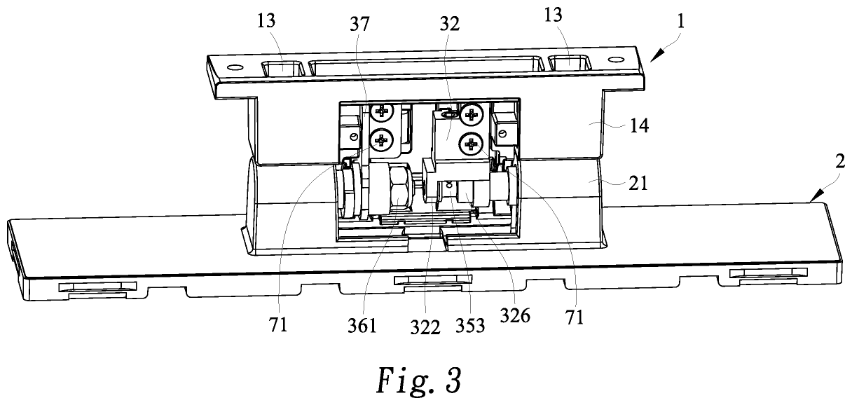

As shown in FIG. 1, FIG. 2, and FIG. 3, a device with an adjusted pause-type hinge 3 according to an embodiment of the present invention, the first seat body 1 includes: two tanks 14, the notch 13, the slot cover 11, at least one fixing groove 111, and the side cover 12. Two tanks 14 are located at both ends of the first seat body 1. The tank 14 has a notch 13 and a slot cover 11, and the two tanks 14 are connected by the slot cover 11; wherein the fixing groove 111 is located inside the slot cover 11; and the side cover 12 is combined with the slot cover 11 to form a cavity for accommodating the holding portion 32 and the fixing axis 35.

As shown in FIG. 1, FIG. 2, and FIG. 3, a device with an adjusted pause-type hinge 3 according to an embodiment of the present invention, wherein the second seat body 2 has two shaft grooves 21, one end of the fixing axis 35 is in the cavity 22 of the shaft jointing slot 21. By way of the technical means of the present invention, a combination of the side cover 12 and the slot cover 11 is provided, wherein the side cover 12 has a screw hole 113. The screw hole 113 of the side cover 122 can be inserted through the screw 71 and then screwed into the screw holes 113 on the inner side of the slot cover 11. Therefore, the holding portion 32 and the fixing axis 35 can be quickly replaced and assembled after the side cover 12 is disassembled during maintenance or assembly.

As shown in FIG. 1, FIG. 2, and FIG. 3, a device with an adjusted pause-type hinge 3 according to an embodiment of the present invention, wherein the first seat body 1 is connected to the second seat body 2, which is the holding portion 32 and the fixing axis 35 are combined to form a pause-type hinge 3. The holding portion 32 has a shaft joint portion 326 and an extending portion 322. The fixing axis 35 passes through the shaft joint portion 326 and the extending portion 322, so as to rotate and connect the holding portion 32 in shaft manner. The holding portion 32 has a protruding portion 34. The fixing axis 35 has at least one fixing hole 353. The protruding portion 34 is elastically stretched to engage the fixing hole 353 to form a pausing position of a corresponding angle.

As shown in FIG. 1, FIG. 2, and FIG. 3, a device with an adjusted pause-type hinge 3 according to an embodiment of the present invention, wherein the holding portion 32 further includes: an accommodating hole 323, The spring 33, and the crew nut 31. The accommodating hole 323 penetrates the holding portion 32; the spring 33 is accommodated in the accommodating hole 323, and the protruding portion 34 is attached to one end of the spring 33 and stretches to one end of the accommodating hole 323 via the spring 33; and the screw nut 31 is screwed to the other end of the accommodating hole 323 to hold the other end of the spring 33. Therefore, by the technical means of the present invention, a screw nut 31 is provided to screw the spring 33 into the accommodating hole 323 of the holding portion 32. When the elasticity of the spring 33 is exhausted, the spring 33 in the accommodating hole 323 can be replaced by opening the screw nut 31. Keep the device with an adjusted pause-type hinge 3 of the present invention in a long-lasting using state.

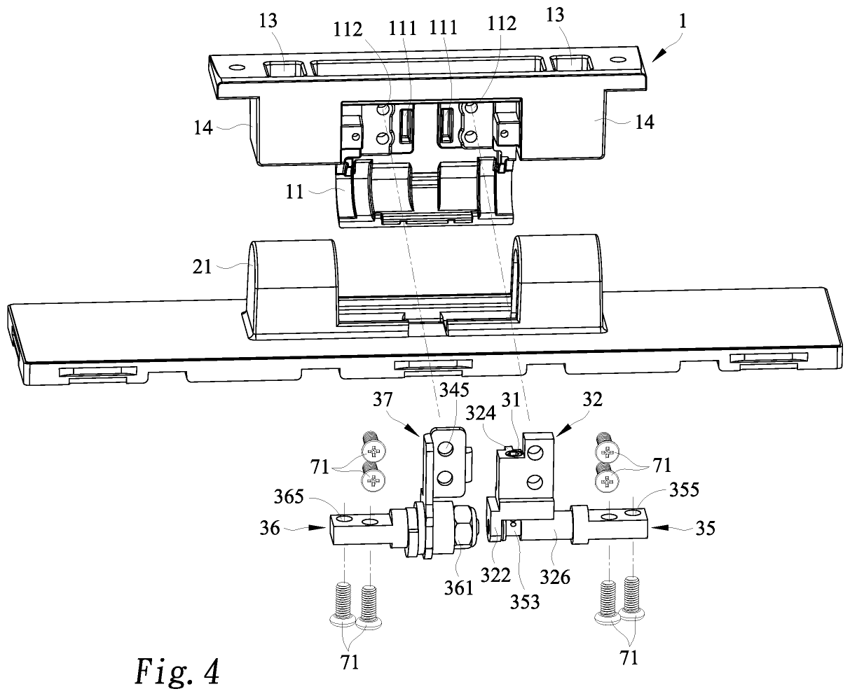

As shown in FIG. 1, FIG. 2, FIG. 3, and FIG. 4, a device with an adjusted pause-type hinge 3 according to an embodiment of the present invention, wherein the fixing axis 35 has a structure with different shaft diameters extending from an axle center of the fixing axis 35, and the fixing axis 35 further includes: a supporting shaft 351, a ring shaft 352, a fixed-point axis 356, and a fixed shaft 354, wherein a supporting shaft 351 is located at one end of the fixing axis 35, the supporting shaft 351 is rotated and combined through the shaft hole 321 in the extending portion 322 in shaft manner; A ring shaft 352 is adjacent to one end of the supporting shaft 351, and the ring shaft 352 is rotated and combined in the extending portion 322 in shaft manner; A fixed-point axis 356 is adjacent to the other end of the ring shaft 352, the fixed-point axis 356 has the fixing hole 353, and the fixing hole 353 is recessed on the surface of the fixed-point axis 356; and a fixed shaft 354 is adjacent to the other end of the fixed-point axis 356, and the fixed shaft 354 penetrates the shaft joint portion 326.

As shown in FIGS. 2, 3, and 4, a device with an adjusted pause-type hinge 3 according to an embodiment of the present invention, wherein a shaft diameter of the fixed shaft 354 from the axle center and a shaft diameter of the ring shaft 352 from the axle center are respectively larger than a shaft diameter of the fixed-point axis 354 from the axle center, and the protruding portion 34 is elastically stretched between the fixed shaft 354 and the ring shaft 354.

As shown in FIG. 1, FIG. 2, FIG. 3, and FIG. 4, a device with an adjusted pause-type hinge 3 according to an embodiment of the present invention, the second seat body 2 has two shaft-jointing slot 21. One end of the fixing axis 35 is in the cavity 22 of the shaft-jointing slot 21, there are a plurality of fixed-point holes 355 on the fixing axis 35, and the second seat body 2 is screwed and fixed to the fixing axis 35 via a screw 71. Therefore, only the holding portion 32 and the fixing axis 35 are generated, when the first seat body 1 and the second seat body 2 rotate correspondingly, the moment to push the pause-type hinge 3 to rotate. In addition, one side of the holding portion 32 has a buckling piece 324 which is engaged with the fixing groove 111 to fix the first seat body 1 and the holding portion 32, wherein the holding portion 32 has a plurality of screw holes 325. The slot cover 11 has a plurality of screw holes 112, and the screw holes 112 of the first base body 1 are screwed and fixed to the holding portion 32 via screws 71. The side cover 12 and the slot cover 11 are combined to form the combined body which is accommodated between the two shaft jointing slots 21. Therefore, the side cover 12 and the slot cover 11 are combined to form the combined body can be flexibly rotated between the two shaft-jointing slots 21.

As shown in FIGS. 3 and 4, a device with an adjusted pause-type hinge 3 according to an embodiment of the present invention, used technical means, except that the holding portion 32 and the fixing axis 35 are combined to a pause-type hinge 3, form a pausing positioning at a specific angle, and further includes a non-pause-type general rotating hinge. The general rotating hinge has a bearing shaft 36 and a linking portion 37 combined to form a hinge, wherein the bearing shaft 36 engages the second seat body 2 and the linking portion 37 are joined to the first seat body 1. One side of the linking portion 37 has a buckling piece 324 which like the holding portion 32, and the buckling piece 324 is engaged with a fixing groove 111. The linking portion 37 has a plurality of screw holes 345, and the first base body 1 is screwed and fixed to the linking portion 37 via a screw 71. The nut 361 is screwed to one end of the bearing shaft 36. The bearing shaft 36 has a plurality of screw holes 365 therebetween, the slot cover 11 has a plurality of screw holes 112, and the screw hole 112 of the first seat body is screwed and fixed to the other end of the bearing shaft 36 via a screw 71.

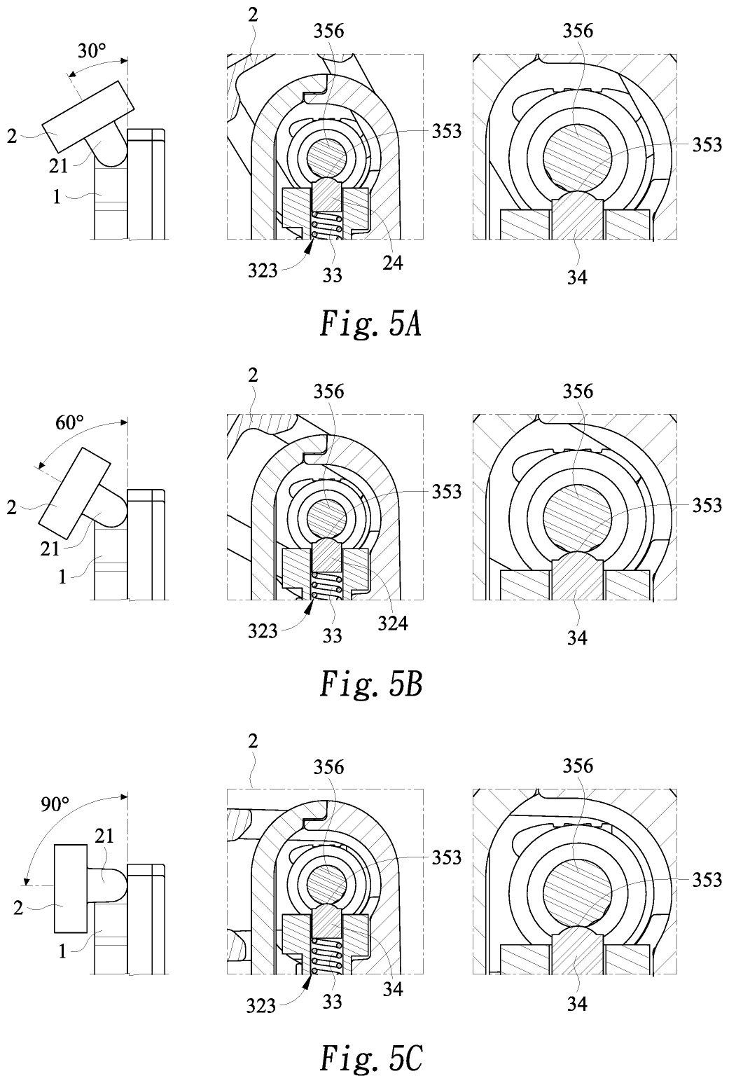

As shown in FIG. 5A, a device with an adjusted pause-type hinge 3 according to an embodiment of the present invention, the first seat body 1 and the second seat body 2, and the display screen is supported at a 30-degree angle to hold the display. Keep the screen being rotated at a specific angle. The protruding portion 34 is elastically stretched between the f fixed shaft 354 and the ring shaft 352, and can be positioned in the 30-degree fixing hole 353 correspondingly, so as to form a 30-degree positioning angle of the pausing position.

As shown in FIG. 5B, a device with an adjusted pause-type hinge 3 according to an embodiment of the present invention, the first seat body 1 and the second seat body 2, and the display screen is supported at a 60-degree angle to hold the display. Keep the screen being rotated at a specific angle. The protruding portion 34 is elastically stretched between the f fixed shaft 354 and the ring shaft 352, and can be positioned in the 60-degree fixing hole 353 correspondingly, so as to form a 60-degree positioning angle of the pausing position.

As shown in FIG. 5C, a device with an adjusted pause-type hinge 3 according to an embodiment of the present invention, the first base body 1 and the second base body 2 support the display screen at a 90-degree rotated angle to hold the display. Keep the screen being rotated at a specific angle. In an embodiment of the present invention, the protruding portion 34 is elastically stretched between the fixed shaft 354 and the ring shaft 352, and can be positioned in a plurality of positioning holes 353 to form a positioning angle of a pausing position. Under the rotation of 30 degrees, 60 degrees, and 90 degrees, the torque generated by the corresponding rotation of the first seat body 1 and the second seat body 2 drives the rotation of the pause-type hinge 3. When the rotation reaches the required angle, the protruding portion 34 is elastically snapped into the fixing hole 353 to form the positioning and fixing position of the first seat body 1 and the second seat body 2. If another corresponding angle of the first seat body 1 and the second seat body 2 is selected, Through the corresponding rotation of the first seat body 1 and the second seat body 2, the generated torque pushes the rotation of the pause-type hinge 3, so as to enter the selected another pause-type positioning position.

The above descriptions and explanations are only descriptions of the preferred embodiments of the invention. Those who has general knowledge of this technology should make other modifications based on the scope of patent applications defined below and the above descriptions, but these modifications should still be within the creative spirit of the invention and within the scope of the rights of the invention.

What is claimed is:

1. A device with an adjusted pause-type hinge, comprising:
a holding portion and a fixing axis are combined to form a pause-type hinge, the holding portion has a shaft joint portion and an extending portion, the fixing axis passes through the shaft joint portion and the extending portion in shaft manner for rotated and combined in the holding portion, the holding portion has a protruding portion, the fixing axis has at least one fixing hole, and the protruding portion is elastically stretched and engaged with the fixing hole to form a pausing position of a corresponding angle.

2. The device with an adjusted pause-type hinge as claimed in claim 1, further including:
a first seat body, the first seat body connected to the holding portion; and
a second seat body, the second seat body is connected to the positioning shaft, the first seat body is rotated on the second seat body through a common axle center of the holding portion and the fixing axis, and at the pausing position of the corresponding angle, which is formed by the first seat body and the second seat body.

3. The device with an adjusted pause-type hinge as claimed in claim 2, wherein the holding portion further includes:
an accommodating hole, the accommodating hole penetrates the holding portion;
a spring, the spring is accommodated in the accommodating hole, the protruding portion is attached to one end of the spring, and the protruding portion is stretched to one end of the accommodating hole by the spring; and
a screw nut, which is screwed to the other end of the accommodating hole, so as to hold the other end of the spring.

4. The device with an adjusted pause-type hinge as claimed in claim 3, wherein the fixing axis has a structure with different shaft diameters extending from an axle center of the fixing axis, and the fixing axis further includes:
a supporting shaft is located at one end of the fixing axis, the supporting shaft is rotated and combined in the extending portion in shaft manner;
a ring shaft is adjacent to one end of the supporting shaft, and the ring shaft is rotated and combined in the extending portion in shaft manner;
a fixed-point axis is adjacent to the other end of the ring shaft, the fixed-point axis has the fixing hole, and the fixing hole is recessed on the surface of the fixed-point axis; and
a fixed shaft is adjacent to the other end of the fixed-point axis, and the fixed shaft penetrates the shaft joint portion.

5. The device with an adjusted pause-type hinge as claimed in claim 4, wherein a shaft diameter of the fixed shaft from the axle center and a shaft diameter of the ring shaft from the axle center are respectively larger than a shaft diameter of the fixed-point axis from the axle center, and the protruding portion is elastically stretched between the fixed shaft and the ring shaft.

6. The point-type hinge adjustment device as described in claim 5, wherein the first seat body includes:
two tanks are located at both ends of the first seat body, and the tank has a notch;
a slot cover, the two tanks are connected by the slot cover;
at least one fixing groove, the fixing groove is located inside the slot cover; and
a side cover is combined with the slot cover to form a cavity for accommodating the holding portion and the fixing axis.

7. The point-type hinge adjustment device as described in claim 6, wherein the second seat body has two shaft jointing slots, and one end of the fixing axis is located in a cavity of the shaft-jointing slot.

8. The device for adjusting a hinged hinge as described in claim 7, wherein a buckling piece is provided on one side of the holding portion, and the buckling piece is engaged with the fixing groove.

9. The device for adjusting a hinged hinge as described in claim 8, wherein the side cover is combined with the slot cover as a combined body which is accommodated between the two shaft jointing slots.

10. The device for adjusting the hinged hinge described in claim 2, further including:
a bearing shaft and a linking portion are combined to form a hinge, wherein the bearing shaft is connected to the second seat body, and the linking portion is connected to the first seat body.
